(19) United States
(12) Patent Application Publication
(10) Pub. No.: US 2020/0263739 A1
(43) Pub. Date: Aug. 20, 2020

(54) HOMOGENIZED SURFACE PRESSURE IN AN OVERLOAD CLUTCH

(71) Applicant: Schaeffler Technologies AG & Co. KG, Herogenaurach (DE)

(72) Inventor: Michael Metz, Forbach (DE)

(73) Assignee: Schaeffler Technologies AG & Co. KG, Herzogenaurach (DE)

(21) Appl. No.: 16/061,555

(22) PCT Filed: Jan. 4, 2017
(86) PCT No.: PCT/DE2017/100004

§ 371 Date: Jun. 12, 2018

(30) Foreign Application Priority Data
Jan. 8, 2016 (DE) 102016200134.5

(51) Int. Cl. F16D 7/02; F16D 1/08; F16F 15/131

(52) U.S. Cl. CPC F16D 7/021; F16F 15/13469; F16F 15/1315; F16D 1/0858

(57) ABSTRACT

An overload clutch in a drivetrain having a shaft-hub connection between an input part and an output part is disclosed. The overload clutch includes a press fit including a first contact surface and a second contact surface, wherein at least one of the first contact surface and the second contact surface is coated with a soft metal. For homogenizing a surface pressure of the first and second contact surfaces, an oversize allowance between components forming a shaft and a hub is selected prior to joining the shaft and the hub such that during the joining a yield point of the soft metal is reached or exceeded.

### CROSS-REFERENCE TO RELATED APPLICATIONS

This application is the U.S. National Phase of PCT Appln. No. PCT/DE2017/100004 filed Jan. 4, 2017, which claims priority to DE 10 2016 200 134.5 filed Jan. 8, 2016, the entire disclosures of which are incorporated by reference herein.

### TECHNICAL FIELD

The present disclosure relates to an overload clutch in a drivetrain having a shaft-hub connection between an input part and an output part, wherein the overload clutch in the form of a press-press soldered connection includes a press fit.

### BACKGROUND

A press-press soldered connection refers to the combination of a press-fit connection and a press-soldered connection. Applying a thin layer of solder different from the parent metal of the shaft and of the hub to at least one of the joining surfaces of the press-fit connection allows the joined connection to transmit a greater torque. This results neither in a change in the chemical composition nor in thermal deformation of the joined parts. The press-press soldered connection is a special form of soldering and is classed as one of the cohesive material joint connections.

DE 10 2005 026 713 A1 discloses a press-press soldered connection for connecting transmission components, such as a ratchet wheel or a clutch body, for example, to a shaft. In press-press soldered connections joining surfaces of the press-fit connection are coated with a layer of solder and then joined. The layer of solder is preferably applied to the relevant joining surfaces of the shaft and/or the hub by means of electro-chemical cutting, galvanizing.

DE 10 2010 025 579 A1 shows a torque transmission device having a drive-side flywheel and an output-side vibration damping device, between which a slipping clutch is arranged. The slipping clutch here is assigned to a drive-side drive disk connected to the flywheel. The DE 10 2007 059 409 A1 and DE 10 2009 033 864 A1 show dual-mass flywheels, the input part of which includes a primary flywheel mass, and an output part having a secondary flywheel and rotatable in relation to the input part in opposition to the action of an energy storage device. The documents cited both show torque transmission devices which include a slipping clutch for limiting the torque. The slipping clutch limits a torque that can be transmitted by the dual-mass flywheel. In order to reduce peak torques which exceed a set maximum torque, the tensioned components of the slipping clutch are, at least briefly, rotatable relative to one another. In this way so-called load cycle impacts, which besides sacrificing comfort might also lead to damage in the drivetrain and to fracturing of the bow-springs in the dual-mass flywheel, can be prevented or at least minimized.

The technical background of the present disclosure also encompasses the older German patent application No. 10 2015 200 846.0 not previously published, which was filed by the applicant on Jan. 20, 2015.

### SUMMARY

The object of the present disclosure is to afford an overload clutch having an improved distribution of the surface pressure, which can furthermore be achieved easily and cost-efficiently within the overall space available, particularly of a dual-mass flywheel.

According to the present disclosure, for homogenizing a surface pressure of the press fit of the overload clutch, the shaft-hub connection is designed so that a defined oversize allowance is provided between the shaft and the hub. The oversize allowance is selected prior to joining in such a way that, when joining the components forming the shaft and the hub together, a yield point of the soft metal or the solder that is used for coating at least one contact surface of the press-press soldered connection, is reached or exceeded. In so doing a plastic deformation of the soft metal occurs, wherein the stresses are limited approximately to the yield point. These measures give rise to an optimum distribution of the surface pressure in the press fit and hence a homogenized surface pressure.

By purposely exploiting the lower strength of the solder or the soft metal layer as compared to the material of the coated component assists the provision of a desired homogenized surface pressure over the entire contact surface of the press-press soldered connection and of the press fit. The press-press soldered connection of the overload clutch advantageously forms both a torque transmission element and a torque-limiting element. Through a specific input of energy, training, it is possible to increase the number of cohesive material connections produced in the joint after joining. This can be done by purposely rotating the parts to be joined, thereby introducing so much energy that the solder applied is diffused into the contact surface of the shaft and/or the hub. The press-press soldered connection can in a run-in period advantageously be trained to a specific, preferably a maximum admissible torque, so that on reaching the maximum torque the press-press soldered connection of the overload clutch functions as a torque-limiter.

For the application of a soft metal or solder to at least one contact surface of the parts of the press-press soldered connection to be joined a galvanic coating is preferably provided. Zinc, copper or aluminum are primarily suited as solder materials, a good connection strength being achievable with zinc, in particular. The shaft and hub components, with an oversize allowance between them, may be joined together by longitudinal or transverse pressing, in particular using mechanical or hydraulic jigs and fixtures.

According to the present disclosure, an equalizing element is assigned for homogenizing a surface pressure of contact surfaces of the press fit of the shaft-hub connection of an overload clutch. For this purpose, the equalizing element forming an additional component is supported against the components forming the shaft and the hub via contact surfaces of different sizes. The larger contact surface of the two differently sized contact surfaces of the equalizing element is here assigned to the press-press soldered connection. In a preferred embodiment the equalizing element is supported directly against the component forming the shaft. Alternatively, an intermediate element can where necessary be inserted between the shaft and the equalizing element. Due to the specific influence exerted on the size of the contact surface of the press fit, the use of the equalizing element according to the present disclosure affords an advantageous, reduced component rigidity or radial rigidity in the end zones or hub edges of the contact surfaces of the shaft-hub connection. Consequently, the component geometry according to the present disclosure eliminates detrimental increases in the stresses hitherto often occurring in edge zones or hub edges, and edge wearing of contact surfaces in shaft-hub connections or press-press soldered connections. This positive effect can be enhanced by the use of an equalizing element made from a relatively soft material. The present disclosure thereby advantageously ensures a very largely constant and thereby optimal distribution of the surface pressure and consequently a desired homogenized surface pressure over the entire area of the press fit.

Embodiments according to the present disclosure are capable of achieving effective overload clutches through measures that are easy and cost-efficient to implement. The proposed overload clutches are suitable for torque transmission devices, in particular for dual-mass flywheels, in the drivetrain of motor vehicles. These solutions advantageously afford the opportunity for improving a reproducibility of the overload or slip torque of an overload clutch.

The overload clutch, the shaft-hub connection or press-press soldered connections of which include an equalizing element, may he used between a secondary flywheel mass acting as shaft and the hub forming a flange in a dual-mass flywheel. A shoe, which is supported against the secondary flywheel mass directly via a first contact surface or indirectly via an additional component, is preferably suitable as equalizing element. The size of the first contact surface of the equalizing element against the secondary flywheel mass is here greater than that of the second contact surface with which the equalizing element bears on the hub.

According to a further embodiment of the present disclosure, a very largely trapezoidal cross-sectional profile is provided for the equalizing element. Here a width of the equalizing element tapers continuously from the press fit in the direction of the hub. Alternatively, the present disclosure includes an inversely arranged equalizing element of trapezoidal design, which tapers constantly from the hub in the direction of the secondary flywheel mass or the intermediate plate. In this case the press-press soldered connection is provided between the equalizing element and the hub, wherein the equalizing element is rotationally fixed to the secondary mass or the intermediate plate. This design construction produces different-sized contact surfaces of the equalizing element, so that end zones of the larger contact surface of the equalizing element each have a reduced radial rigidity. This effect means that in the operating state of the dual-mass flywheel end zones of the equalizing element yield or spring away to a limited degree, owing to the reduced radial rigidity under load.

A further development of the present disclosure provides for an indirect seating of the equalizing element against the secondary flywheel mass. This arrangement, provided as an alternative to a direct seating of the equalizing element, affords a way, for example, of simplifying assembly. For this purpose, an intermediate plate, which partially encloses the secondary flywheel mass and against which the shoe or the equalizing element is supported, is preferably provided. The equalizing element is furthermore pressed into a central aperture of the hub. For effective, rotationally fixed seating of the equalizing element, the aperture comprises a profiling, in particular a toothing, which during the pressing-in process cuts into the external contour of the equalizing element forming a positive interlock.

In order to determine a defined assembly position and to fix it securely in place, the equalizing element in the fitted state is supported against the hub by way of a shoulder and is secured on the opposite side of the hub by means of calking. A sealing membrane, which is oriented in relation to the secondary mass, can furthermore be inlayed between the equalizing element, preferably between its shoulder, and the hub.

The equalizing element is preferably made from a relatively soft metallic material with no measures taken to increase its strength. A soft steel or aluminum is suited to this purpose, for example. The equalizing element, according to the present disclosure designed as a shoe, may here be combined with a surrounding construction, the components of which are made from different materials.

### BRIEF DESCRIPTION OF THE DRAWINGS

Further features and details of the present disclosure are revealed by the following description, in which an exemplary embodiment is described with reference to the drawings. Here the features mentioned in the claims and in the description may each be essential for the present disclosure either individually or in any combination. In the drawings:

FIG. 1 in a half-section shows a dual-mass flywheel with integral overload clutch; and

FIG. 2 shows an enlarged representation of details of the dual-mass flywheel according to FIG. 1.

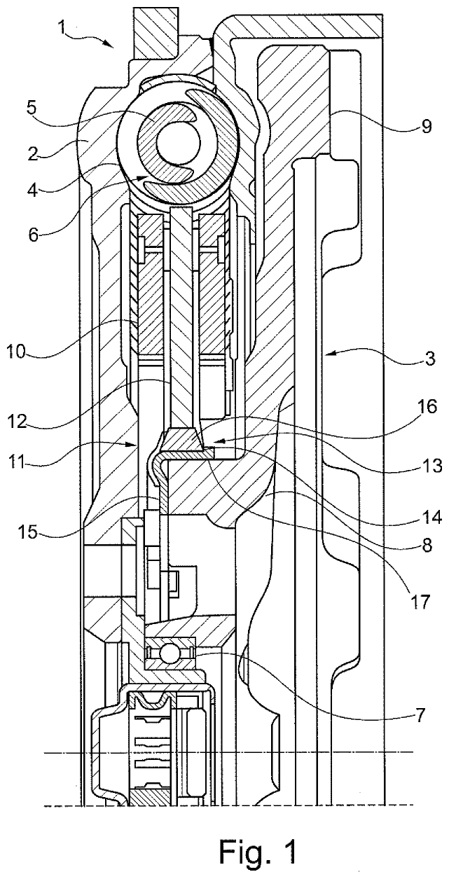

FIG. 1 shows a sectional representation of a dual-mass flywheel 1, rotatable about an axis of rotation, that may also be referred to as a torsional-vibration damper. The dual-mass flywheel 1 that may also be described as a torque transmission device of very largely known type is intended, in particular, for a drivetrain of a motor vehicle not depicted in FIG. 1. Here an input part 2 forming a primary flywheel mass is preferably assigned to a crankshaft of an internal combustion engine, and an output part 3 is assigned via a friction clutch to a transmission. The input part 2 and output part 3 are formed as disk parts, which together form a circumferential annular space 4, into which the bow-springs 5 of a spring device 6 are inserted and guided. The output part 3 is rotatably supported by means of a rolling-contact bearing 7 and in relation to the input part 2 is rotatable to a limited degree in relation to the input part 2 against the action of the spring device 6. The output part 3 is formed from the secondary flywheel mass 8 and a flange part 9. An overload clutch 11 is integrated into the dual-mass flywheel 1 as impact protection. The overload clutch 11 constructed as a slipping clutch is arranged between a hub 12 designed as a flanged disk and the secondary flywheel mass 8. The hub 12 includes a centrifugal pendulum 10 and by means of drivers (not shown) engages externally in the spring device 6 for end-face support against the bow-springs 5. In relation to the dual-mass flywheel 1, the overload clutch 11 is therefore arranged between the input part 2 and output part 3. A press-press soldered connection 13 including two contact surfaces 16, 17 and forming a press fit 14 is provided as overload clutch 11, wherein at least one of the contact surfaces 16, 17 is coated with a soft metal or a solder.

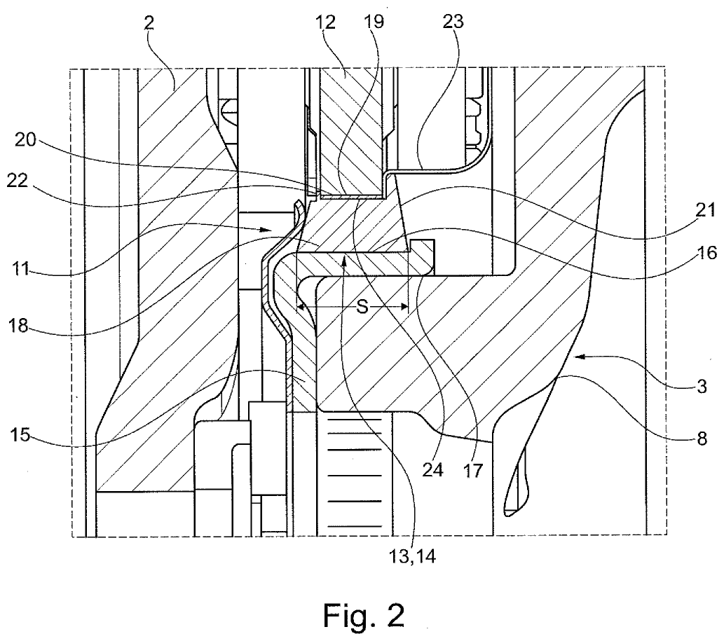

FIG. 2 illustrates further details of the overload clutch 11 and the associated press-press soldered connection 13. The construction of the overload clutch 11 comprises an equalizing element 18 designed as a shoe, which is rotationally fixed to the hub 12. Via a contact surface 16 the equalizing element 18 is supported against a corresponding contact surface 17 of an intermediate plate 15, which together form a press fit 14. The intermediate plate 15 locally encloses an end area of the secondary flywheel mass 8. The equalizing element 18 having a trapezoidal cross-sectional profile tapers continuously from a width S in the area of the press fit 14 in the direction of the hub 12. Consequently, the equalizing element 18 is supported by a larger contact surface 16 against the intermediate plate 15 compared to the contact surface 24 against the hub 12. In order to achieve the press-press soldered connection 13, one of the contact surfaces 16 or 17 is coated with a soft metal as solder, before the components, the hub 12 with associated equalizing element 18 and the secondary flywheel mass 8 with associated intermediate plate 15, are joined together, there being an oversize allowance between the two components. For rotationally fixed arrangement of the equalizing element 18, a profiling 19, which in the joining process cuts into the external contour of the equalizing element 18 to form a positive interlock, is introduced in the aperture 20 of the hub 12. The equalizing element 18 is pressed into a central aperture 20 of the hub 12 until a shoulder 21 bears against the hub 12. This fitted position of the equalizing element 18 is secured by means of calking 22 on the opposite side to the shoulder 21. A sealing membrane 23, which extends in the direction of the output part 3, is furthermore fixed between the shoulder 21 of the equalizing element 18 and the hub 12.

In a first solution according to the present disclosure a homogenization of the surface pressure in the press fit 14 of the overload clutch 11 can be achieved by providing a defined oversize allowance between the shaft, that is to say the secondary flywheel mass 8 or its associated intermediate plate 15, and the hub 12. The oversize allowance is selected prior to joining in such a way that when joining the hub 12 and the shaft together a yield point of the soft metal or the solder that is used for coating at least one of the contact surfaces 16, 17 of the press-press soldered connection 13 is reached or exceeded.

In the second solution according to the present disclosure a homogenization of the surface pressure in the press fit 14 of the overload clutch 11 can be achieved by an equalizing element 18 designed as a shoe, which is supported against the surrounding construction, the intermediate plate 15 and the hub 12, via contact surfaces 16, 24 of different sizes. This design construction results in a reduced radial rigidity in the end zones of the contact surface 16 of the equalizing element 18.

### LIST OF REFERENCE NUMERALS

1 dual-mass flywheel

2 input part

3 output part

4 annular space

5 bow-spring

6 spring device

7 rolling-contact bearing

8 secondary flywheel mass

9 flange part

10 centrifugal pendulum

11 overload clutch

12 hub

13 press-press soldered connection

14 press fit

15 intermediate plate

16 contact surface

17 contact surface

18 equalizing element

19 profiling

20 aperture

21 shoulder

22 calking

23 sealing membrane

24 contact surface

S width (equalizing element)

1-10. (canceled)

11. An overload clutch in a drivetrain having a shaft-hub connection between an input part and an output part, the overload clutch comprising:
a press fit including a first contact surface and a second contact surface,
wherein at least one of the first contact surface and the second contact surface is coated with a soft metal, and
wherein, for homogenizing a surface pressure of the first and second contact surfaces, an oversize allowance between components forming a shaft and a hub is selected prior to joining the shaft and the hub such that during the joining a yield point of the soft metal is reached or exceeded.

12. The overload clutch of claim 11, wherein the overload clutch is provided as a press-press soldered connection.

13. The overload clutch of claim 11, wherein the shaft includes a secondary flywheel mass and an intermediate plate, the intermediate plate comprising one of the first contact surface or the second contact surface.

14. The overload clutch of claim 13, further comprising an equalizing element rotationally fixed to the hub and comprising the other one of the first contact surface or the second contact surface, wherein the equalizing element is supported indirectly against the secondary flywheel mass via the intermediate plate.

15. The overload clutch of claim 11, wherein the overload clutch is arranged in a dual-mass flywheel between the hub and a secondary flywheel mass forming the shaft.

16. A dual-mass flywheel, comprising:
an input part formed from a primary flywheel mass;
an output part formed from a secondary flywheel mass and a flange part; and
an overload clutch arranged between the input part and the output part, the overload clutch including an equalizing element rotationally fixed to a hub, wherein the equalizing element has a first contact surface supported against a second contact surface of an intermediate plate forming a press fit therebetween.

17. The dual-mass flywheel of claim 16, wherein at least one of the first contact surface or the second contact surface is coated with a soft metal to form the press fit therebetween.

18. The dual-mass flywheel of claim 16, wherein a width of the equalizing element tapers continuously from the first contact surface to a radially opposite surface of the equalizing element, wherein the equalizing element is supported by a larger contact surface against the intermediate plate compared to a contact surface against the hub.

19. The dual-mass flywheel of claim 16, wherein the equalizing element is supported by a larger contact surface against the intermediate plate compared to a contact surface against the hub for homogenizing a surface pressure of the first and the second contact surfaces.

20. The dual-mass flywheel of claim 16, wherein an oversize allowance between the hub with associated equalizing element and the secondary flywheel mass with associated intermediate plate is selected prior to joining, in such a way that during the joining a yield point of a soft metal used for coating the first contact surface or the second contact surface is reached or exceeded for homogenizing a surface pressure of the first and the second contact surfaces.

21. The dual-mass flywheel of claim 16, wherein the intermediate plate encloses an end area of the secondary flywheel mass.

22. The dual-mass flywheel of claim 16, wherein the equalizing element is pressed into an aperture of the hub, and wherein in a pressing-in process, a profiling of the aperture cuts into an external contour of the equalizing element.

23. The dual-mass flywheel of claim 16, wherein in a limit position, the equalizing element is supported against the hub by way of a shoulder and is secured on an opposite side of the hub by calking.

24. The dual-mass flywheel of claim 16, wherein a sealing membrane is arranged between the equalizing element and the hub.

25. The dual-mass flywheel of claim 16, wherein the equalizing element is made from a soft metallic material.
